(19) United States
(12) Patent Application Publication
(10) Pub. No.: US 2015/0286169 A1
(43) Pub. Date: Oct. 8, 2015

(54) Sublimation Transfer Dyeing Method And Method For Suppressing Non-Image Area Staining

(71) Applicants: NIPPON KAYAKU KABUSHIKI KAISHA, Tokyo (JP); ETOWAS CO., LTD., Osaka (JP)

(72) Inventors: Makoto Teranishi, Tokyo (JP); Yuji Suzuki, Tokyo (JP); Hirokazu Kitayama, Tokyo (JP); Yoshihiro Takai, Osaka (JP); Kousuke Takai, Osaka (JP)

(21) Appl. No.: 14/437,286

(22) PCT Filed: Nov. 6, 2013
(86) PCT No.: PCT/JP2013/079969

§ 371 Date: Apr. 21, 2015

(30) Foreign Application Priority Data
Nov. 8, 2012 (JP) 2012-246309

(51) Int. Cl. G03G 15/20; G03G 9/09; G03G 9/087; G03G 15/16; G03G 9/097

(52) U.S. Cl. CPC G03G 15/2003; G03G 15/16; G03G 9/09708; G03G 9/08728; G03G 9/0926

(57) ABSTRACT

[Object] To provide: a sublimation transfer printing method of a dry developing system, particularly a dry nonmagnetic developing system, still particularly a dry nonmagnetic one -component developing system, said sublimation transfer printing method being capable of achieving a high color depth and inhibiting the staining of non-image areas of a printed product; a printed product obtained by the printing method; an intermediate recording medium which is to be used in the printing method; and a toner.

[Means of Achievement] A sublimation transfer printing method which comprises adhering a toner to an intermediate recording medium according to an electro-photographic process, and transferring the dye contained in the toner adhered to the intermediate recording medium to an object to be printed through the sublimation of the dye, wherein: the toner comprises a styrene-acryl resin, a sublimable dye and an external additive as essential components; and the external additive contains strontium titanate as an essential component. According to the sublimation transfer printing method, a high-quality printed product which has a high color depth and the non-image areas of which are not stained can be provided.

[Selected Drawing(s)] None

### TECHNICAL FIELD

The present invention relates to a sublimation transfer dyeing method for dyeing an object to be dyed using an intermediate recording medium to which a toner for sublimation transfer has been imparted, to a dyed product obtained by the dying method, to a toner used in the dyeing method, and to a method for suppressing staining of a non-image area using the sublimation transfer dyeing method.

### BACKGROUND ART

Dyeing methods using an electrophotographic process for hydrophobic fibers such as polyester cloth or hydrophobic resins such as PET films can be broadly classified into two categories.

Specifically, these two categories include direct methods in which a toner is directly imparted to an object to be dyed, after which a dye contained in the toner is ingrained by heat treatment into the object to be dyed.; and sublimation transfer methods in which a toner is imparted to paper or another intermediate recording medium, after which the toner-imparted surface of the intermediate recording medium and the object to be dyed are superposed on each other and then heat-treated, and the dye contained in the toner is sublimation--transferred to the object to be dyed.

Of these two categories of methods, sublimation transfer methods are considered to be suitable for dyeing applications in which texture is important, such as for sports apparel and other clothing items. Disperse dyes suitable for dyeing hydrophobic fibers, or, among oil-soluble dyes, particularly easy-sublimating dyes having excellent suitability for sublimation transfer to hydrophobic fibers by heat treatment, and the like are used as dyes in toners used in sublimation transfer methods.

When a sublimation transfer method is used in an electrophotoqraphic process, it is possible to cause only the dye component of the plurality of components constituting the toner to be ingrained in the fibers from the intermediate recording medium. As a result, toner components other than the dye do not adhere to the dyed cloth, and some advantages are obtained, for example, which are as follows: the method is suitable for applications in which the texture of the material is considered important, such as for clothing items, sheets, sofas, and other interior items, or bedding, for example, and it is possible to reduce the risk of toner components causing rash, eczema, and the like in people having sensitive skin.

Having no need for washing/drying and other steps also brings some advantages, which are as follows: the dyeing steps are significantly reduced, and the need of a high-cost washing/drying line, wash water treatment facility, or the like which requires a large amount of space and large amounts of energy to operate are eliminated.

Consequently, a sublimation transfer method is considered as an excellent dyeing method capable of dyeing in a small space.

An inkjet process is commonly used as a means for dyeing fibers by a sublimation transfer method.

However, sublimation transfer dyeing by an inkjet process has drawbacks in that the organic solvent which is one component of the ink is volatilized by heat during dye transfer, and contaminates the work environment.

In an electrophotographic process, however, volatile components are not present in the toner thereof and therefore do not contaminate the work environment, the advent of a photosensitive drum capable of an output width of 900 mm and the resultant size of dyeable fibers (or cloth structured from the fibers) enables application to the field of sports apparel, the dyed surface area per unit time is greater than in an inkjet process (serial printing process), and other advantages are obtained. Electrophotographic processes have therefore garnered attention in recent years.

Developers used in dry electrophotographic processes include one--component developers comprised of a toner solely and two-component developers comprised of a toner and a carrier. Dry-toner development processes using these developers are further classified according to differences in basic development functions, which are (1) replenishment of toner, (2) charging of toner, (3) formation of a thin-layer coating of the developer on a development roller, (4) development, and (5) elimination of development history.

These processes are generally classified into two types including magnetic one-component development processes and nonmagnetic one-component development processes according to what is used to impart a charge to the toner and to convey the toner when an electrically insulating toner is used.

In a magnetic one-component development process, a magnetic toner containing a magnetic body is used alone as the developer. Magnetic force acting on the toner is used directly for toner conveyance, and rubbing against the development roller is primarily used for imparting an electric charge to the toner by friction.

Meanwhile, in a nonmagnetic one-component development process, a nonmagnetic toner is used alone as the developer. In this configuration, rubbing against the development, roller is primarily used for imparting an electric charge to the toner by friction, the toner is conveyed using mechanical conveyance and the electrostatic force created by frictional electric charging due to rubbing against the development roller. Nonmagnetic one-component development processes include contact-type processes in which development is performed while maintaining a toner layer in contact with a photosensitive body and non-contact-type processes in which development is performed while maintaining a non-contact state between a photosensitive body and a development roller for retaining a toner layer.

Of the aforementioned processes, in an image formation method using a dry nonmagnetic one-component development process in particular, it is known that there is usually variation in the amount of electric charge of the toner. Therefore, toner having a small amount of electric charge or toner charged in the opposite polarity to the original charge polarity of the toner adheres to the non-image area portion on the intermediate recording medium (i.e., on the intermediate recording medium, the “background” portion thereof where an image formation is not intended and no toner is expected to adhere), and staining of the non-image area portion (hereinafter referred to as “staining of the non--image area”) is extremely prone to occur.

Essentially, staining of the non-image area on the intermediate recording medium is not significantly prominent insofar as the staining is not severe enough to be clearly confirmed visually. However, when the intermediate recording medium which does not appear to have prominent staining of the non-image area is used in sublimation transfer dyeing, and an object to be dyed is subjected to sublimation transfer, staining of the non-image area of the dyed product (meaning the object obtained by dyeing an object to be dyed by sublimation transfer) becomes extremely prominent, which is a significant problem in sublimation transfer dyeing.

There is Therefore a strong need to address the problem of suppressing staining of the non-image area of the dyed product in a sublimation transfer dyeing method.

However, it is generally difficult to suppress staining of the non-image area and achieve high dyeing density at the same time in a sublimation transfer dyeing method, and it is recognized than there is a tradeoff between these objects. Consequently, a sublimation transfer dyeing method whereby high dyeing density is achieved and staining, of non-image areas can be adequately suppressed has not yet been discovered.

Sublimation transfer dyeing using an electrophotographic process is disclosed in Patent References 1 through 5 below, for example.

### PRIOR ART REFERENCES

### Patent References

Patent. Reference 1: Japanese Laid-open. Patent Application No. 02-295787

Patent Reference 2: Japanese Laid-open Patent Application No. 06-051591

Patent Reference 3: Japanese Laid-open Patent. Application No. 10-053628

Patent. Reference 4: Japanese Laid-open. Patent Application. No 2000-029238

Patent Reference 5: Japanese National Publication No. 2006-500602

### SUMMARY OF THE INVENTION

### Problems to be Solved by the Invention

The object of the present invention is to provide: a sublimation transfer dyeing method for a dry development process, especially a dry nonmagnetic development process, and particularly a dry nonmagnetic one-component development process, the sublimation transfer dyeing method being capable of achieving high dyeing density and suppressing staining of a non-image area of a dyed product; a dyed product dyed by the dyeing method; an intermediate recording medium used in the dyeing method; and a toner.

### Means used to Solve the Above-Mentioned Problems

As a result of earnest investigation aimed at overcoming the aforementioned problems, the inventors achieved the present invention based on the findings that the problems can be overcome by a sublimation transfer dyeing method which uses a specific toner. The present invention specifically relates to items [1] through [11] below.

[1]

A sublimation transfer dyeing method, comprising:
attaching a toner to an intermediate recording medium by an electrophotographic process, and

sublimation-transferring a dye contained in the toner attached to the intermediate recording medium to an object to be dyed,

wherein the toner contains at least a styrene-acrylic resin, a sublimable dye, and an external additive, and

wherein the external additive contains at least strontium titanate.

[2]

The sublimation transfer dyeing method according to [1], wherein the electrophotographic process is a dry development process.

[3]

The sublimation transfer dyeing method according to [1] or [2], wherein the object to be dyed is selected from the group consisting of a hydrophobic fiber or a structure thereof, a film or sheet comprised, of a hydrophobic resin, and a fabric, glass, metal, and ceramics coated with a hydrophobic resin.

[4]

A dyed product dyed by the sublimation transfer dyeing method according no any of [1] to [3].

A toner used in the sublimation transfer dyeing method according to any of [1] to [3],

wherein the toner contains at least a styrene-acrylic resin, a sublimable dye, and an external additive, and

wherein the external additive contains at least strontium titanate.

[6]

An intermediate recording medium used in the sublimation transfer dyeing method according to any of [1] to [3],

wherein the toner is attached to the intermediate recording medium,

wherein the toner contains at least a styrene-acrylic resin, a sublimable dye, and an external additive, and

wherein the external additive contains at least strontium titanate.

[7]

A method for suppressing staining of a non-image area, using the sublimation transfer dyeing method according to any of [1] to [3].

[8]

A dyed product dyed by the sublimation transfer dyeing method according to any of [1] to [3], in which staining of a non-image area is suppressed.

[9]

A method for suppressing staining of a non-image area, using the toner according to [5].

[10]

A method for suppressing staining of a non-image area, using the intermediate recording medium according to [6]

[11]

An intermediate recording medium to which the toner according to [5] is attached.

### Advantages of the Invention

According to the present invention, the followings are provided: a sublimation transfer dyeing method by a dry development process, especially a dry nonmagnetic development process, and particularly a dry nonmagnetic one-component development process, the sublimation transfer dyeing method being capable of achieving high dyeing density and suppressing staining of the non-image area of a dyed product; a dyed product dyed by the dyeing method; an intermediate recording medium used in the dyeing method; and a toner.

### BEST MODE FOR CARRYING OUT THE INVENTION

The toner used in the sublimation transfer dyeing method of the present invention contains at least a styrene-acrylic resin, a sublimable dye, and an external additive, and the external additive contains at least strontium titanate.

The styrene-acrylic resin is not particularly limited, but includes a resin obtained by polymerization of two types of monomers, for example, a styrene-based monomer and a monofunctional (meth)acrylic monomer. Here, “(meth)acrylic” means “acrylic” and/or “methacrylic.”

The styrene-based monomer is not particularly limited to, but includes styrene, o-methylstyrene, m-methylstyrene, p-methylstyrene, α-methylstyrene, 4,α-dimethylstyrene, p-ethylstyrene, 2,4-dimethylstyrene, 2,4,6-trimethy styrene, p-n-butyistyrene, p-tert-butyistyrene, p-n-pentyistyrene, p-n-hexylstyrene, p-n-heptylstyrene, p-n-octyistyrene, p-n-nonyistyrene, p-n-decanylstyrene, p-n-dodecylstyrene, p-phenyistyrene, 3,4-dicyclohexylstyrene, and the like. Among these, styrene is preferred. These styrene-based monomers may be used singly or as a mixture of two or more types thereof.

The monofunctional(meth)acrylic monomer is not particularly limited to, but includes methyl acrylate, ethyl acrylate, n-propyl acrylate, isopropyl acrylate, n-butyl acrylate, isobutyl acrylate, n-hexyl acrylate, cyclohexyl acrylate, 2-ethylhexyl acrylate, n-octadecyl acrylate, methyl u-chloroacrylate, ethyl n-chloroacrylate, and other acrylic monomers; methacrylic acid, methyl methacrylate, ethyl methacrylate, n-propyl methacrylate, isopropyl methacrylate, n-butyl methacrylate, isobutyl methacrylate, tert-butyl methacrylate, n-hexyl methacrylate, 2-ethylhexyl methacrylate, n-cyclohexyl methacrylate, n-dodecyl methacrylate, n-tridecyl methacrylate, n-octadecyl methacrylate, and other methacrylic monomers; and the like. Among these, ethyl acrylate, n-propyl acrylate, isopropyl acrylate, n-butyl acrylate, isobutyl acrylate, ethyl methacrylate, n-propyl methacrylate, isopropyl methacrylate, n-butyl methacrylate, isobutyl methacrylate, and tert-butyl methacrylate are preferred, and n-butyl acrylate and n-butyl methacrylate are particularly preferred. These monofunctional (meth)acrylic monomers may be used singly or as a mixture of two or more types thereof.

The styrene-acrylic resin may be a resin containing, in addition to the two types of monomers described above, a polyfunctional vinyl monomer, and obtained by polymerizing these three types of monomers. The polyfunctional vinyl monomer is not particularly limited insofar as the monomer is a compound having two or more ethylenically unsaturated groups per molecule. Specific examples thereof include divinylbenzene, divinylnaphthalene, and other aromatic divinyl compounds; and ethylene glycol di(meth)acrylate, triethylene glycol di(meth)acrylate, tetraethylene glycol di(meth)acrylate, polyethylene glycol di(meth)acrylate, dipropylene glycol di(meth)acrylate, 1,3-butylene glycol di(meth)acrylate, bisphenol A derivative di(meth)acrylates, trimethylolpropane di(meth)acrylate, trimethylolpropane tri(meth)acrylate, pentaerythritold(meth)acrylate, pentaerythritol tri(meth)acrylate, dipentaerythritol tetra(meth)acrylate, and the like. These polyfunctional vinyl, monomers may be used singly or as a mixture of two or more types thereof. Among these, trimethylolpropane tri(meth)acrylate is preferred.

The content of each constituent unit corresponding to each of the monomer described above in the total mass of the styrene-acrylic resin is not particularly limited.

However, the mass-based content of the constituent unit corresponding to the styrene-based monomer in the total mass of the styrene-acrylic resin is usually 50 to 95%, preferably 60 to 90%, and more preferably 70 to 90%. This content tends to improve fixing properties to the intermediate recording medium. Unless otherwise specified, “%” and “parts” are described on a mass basis in the present specification.

Similarly, the content of the constituent unit corresponding to the monofunctional (moth) acrylic monomer is usually 5 to 50%, preferably 10 to 40%, and more preferably 10 to 30%. This content tends to enhance fixing properties to the intermediate recording medium, as well as to enhance storage stability.

When a polyfunctional vinyl monomer is further contained, the content of the constituent unit corresponding to the polyfunctional vinyl monomer is usually 0.05 to 3%, preferably 0.1 to 2%, and more preferably 0.3 to 1%. When a polyfunctional vinyl, monomer is further contained, the contents of the styrene-based monomer and/or the monofunctional (meth)acrylic monomer may be adjusted according to the content of the polyfunctional vinyl monomer.

The styrene-acrylic resin may be obtained by polymerizing the three types of monomers including a styrene-based monomer, a monofunctional (meth)acrylic monomer, and optionally a polyfunctional vinyl monomer, as well as another vinyl monomer as needed.

The other vinyl monomer is not particularly limited to, but includes vinyl monomers containing carboxyl groups such as acrylic acid, methacrylic acid, cinnamic acid, and other unsaturated monocarboxylic acids; maleic acid, fumaric acid, itaconic acid, and other unsaturated dicarboxylic acids; monomethyl maleate, monoethyl maleate, monobutyl maleate, monomethyl fumarate, monoethyl fumarate, monobutyl fumarate, and other unsaturated monocarboxylic acid monoesters.

The styrene-acrylic resin is preferably a resin obtained by polymerizing two types of monomers including a styrene-based monomer and a monofunctional (meth)acrylic monomer.

The number-average molecular weight (Mn) in terms of polystyrene of the THF (tetrahydrofuran) soluble part (hereinafter referred to as “THF soluble part”) of the styrene-acrylic resin as measured by GPC analysis is not particularly limited, but is usually 1,000 to 20,000, preferably 2,000 to 10,000, and more preferably 3,000 to 6,000.

The mass-average molecular weight (Mw) in terms of polystyrene of the THF soluble part of the styrene-acrylic resin as measured by GPC is not particularly limited, but is usually 10,000 co 300,000, preferably 12,000 to 280,000, and more preferably 14,000 to 270,000.

GPC analysis of the THF soluble part was performed using a 1.0% THF solution of the styrene-acrylic resin as the sample solution in a high-speed GPC device (HLC-8320GPC EcoSEC, manufactured by Tosoh. Corporation). The column used for analysis was configured from one TSKgel/SuperHZ1000 column (manufactured by Tosoh. Corporation), one TSKgel/SuperHZ2000 column (manufactured by Tosoh Corporation), and two TSKgel/SuperMultiporeHZ-H columns (manufactured by Tosoh Corporation).

The acid value of the styrene-acrylic resin is not particularly limited, but is usually 0.5 to 100 mg KOH/g, preferably 1 to 80 mg KOH/g, more preferably 5 to 60 mg KOH/g, and more preferably 6 to 40 mg KOH/g.

The styrene-acrylic resin may be manufactured, or a styrene-acrylic resin obtained as a commercial product may be used

When the styrene-acrylic resin is manufactured, the method of manufacturing thereof is not particularly limited, and any method that is publicly known may be used. For example, an emulsion polymerization method, a suspension polymerization method, a bulk polymerization method, a solution polymerization method, or other methods may be used Resins manufactured by a plurality of these polymerization methods may also be mixed together.

The aforementioned styrene-acrylic resins include styrene-acrylic resins obtainable as commercial products. Examples thereof include, the Mitsui. Chemicals products ALMATEX CPR-100, CPR-250, CPR-390, CPR-400, and the like.

The sublimable dye is not particularly limited, but a dye suitable for sublimation transfer is preferred.

“A dye suitable for sublimation transfer ” means a dye for which the staining (polyester) test result in a dry heat treatment test (C method) in the “Test Methods for Color Fastness to Dry Heat [JIS 1, 0879:2005] (confirmed 2010, revised January 20, 2004, published by Japanese Standards Association)” is usually level 3-4 or lower, and preferably level 3 or lower. Among such dyes, the dyes listed below are cited as examples of publicly known dyes.

Yellow dyes include C.I. Disperse Yellow 3, 7, 8, 23, 39, 51, 54, 60, 71, and 86; C.I. Solvent Yellow 114 and 163; and the like.

Orange dyes include C.I. Disperse Orange 1, 1:1,5, 20, 25, 25:1, 23, 56, and 76; and the like.

Brown dyes include. C.1. Disperse Brown 2 and the like. Red dyes include C.I. Disperse Red 11, 50, 53, 55, 55:1, 59, 60, 65, 70, 75, 93, 146, 158, 190, 190:1, 207, 239, and 240; C.I. Vat Red. 41; and the like.

Violet dyes include C.I. Disperse Violet 8, 17, 23, 27, 28, 29, 36, and 57; and the like.

Blue dyes include C.I. Disperse Blue 19, 26, 26:1, 35, 55, 56, 58, 64, 64:1, 72, 72:1, 81, 81:1, 91, 95, 108, 131, 141, 145, 359, and 360; C.1. Solvent Blue 3, 63, 83, 105, and 111; and the like.

The abovementioned dyes may each be used singly, or two or more dyes may be used in combination.

A plurality of dyes are preferably blended to obtain a flue such as black, for example, which is completely different from the original dye. At this time, black dye can be obtained by appropriately blending blue dye as a main component with yellow dye and red dye, for example.

A plurality of dyes may also be blended for such purposes as finely adjusting a blue, yellow, orange, red, violet, black, or other color tone to a more preferred color tone, or obtaining an intermediate color.

The external additive generally increases fluidity of toner particles and improves charging characteristics during development. Numerous types of external additives are known, such as described below, but the external additive must contain at least strontium titanate in order to suppress staining of the non-image area

The -primary particle diameter of the external additive is usually 5 nm to 2 μm, preferably 5 nm to 500 nm, and more preferably 5 nm to 200 nm. The specific surface area of the external additive as measured by a BET method is preferably 20 to 500 m²/g.

Strontium titanate can be obtained as a commercial product. Specific examples thereof include ST, CT, HST-1, HPST-1, and HPST-2 manufactured by Fuji Titanium Industry Co, Ltd.; and SW-100, SW-50C, SW-100C, SW-200C, SW-320C, and the like manufactured by Titan Kogyo, Ltd.

The external, additive may be used alone insofar as the external additive contains strontium titanate, and strontium titanate and another external additive may be used in combination.

Specific examples of external additives that can be used in combination with strontium titanate include silica, alumina, titanium dioxide, barium titanate, magnesium titanate, calcium titanate, zinc oxide, tin oxide, silica sand, clay, mica, wollastonite, diatomaceous earth, chromium oxide, cerium oxide, red oxide, antimony trioxide, magnesium oxide, zirconium oxide, barium sulfate, barium carbonate, calcium carbonate, silicon carbide, silicon nitride, and the like. Among these, silica is preferred.

The aforementioned external additives include external additives obtainable as commercial products. Examples of silica products include AEROSIL® R812, AEROSIL® RX50, AEROSTL® RX200, and AEROSIL® RX300 manufactured by Nippon Aerosil Co., Ltd., TG-6110G, TG-810G, and TG-811F manufactured by Cabot. Japan K.K., H2000/4, H2000T, H05TM, H13TM, H20TM, and H30TM manufactured by Clariant (Japan) K. K. and the like; examples of alumina products include AEROXIDE® AluC 805 manufactured by Nippon Aerosil Co., Ltd., and the like; examples of titanium dioxide products include STT-30A and EC-300 manufactured by Titan Kogyo, Ltd., AEROXIDE® TiO₂ T805 and AEROXIDE® TiO₂ NKT90 manufactured by Nippon Aerosil Co., Ltd., and the like.

The content of styrene-acrylic resin in the toner is riot particularly limited, and an appropriate content can be selected according to purpose. As a guideline, the resin content with respect to the total Mass of the toner is usually 59.5 to 96%, preferably 64.3 to 96%, and more preferably 69.2 so 88.2%.

When strontium titanate and another external additive are used in combination as external additives, as a guideline, the resin content with respect to the total mass of the toner is usually 59.5 to 94%, and preferably 64.3 to 93.1%.

The content of sublimable dye contained in the toner is not particularly limited, and an appropriate content can be selected according to purpose. As a guideline, the sublimable dye content with respect to the total mass of the toner is usually 1 to 40%, and preferably 2 to 35%.

As a guideline, the strontium. titanate content in the toner with respect to the total mass of the toner is usually 0.5 to 3.0%, preferably 0.7% to 2.0%, and more preferably 0.8% to 1.8%.

When strontium titanate and another external additive are used in combination as external additives contained in the toner, the total content of the external additives is not particularly limited, and an appropriate content can be selected. As a guideline, the total content of external additives with respect to the total mass of the toner is usually 0.5 to 5.0%, and preferably 0.7 to 4.9%.

The volume--average particle diameter (P50 Vol.) of the toner is not particularly limited, but is usuallly 1 μm to 12 μm, preferably 4 μm to 12 μm, and more preferably 6 μm to 10 μm.

The average particle diameter is measured using a precision particle size distribution measuring device (Multisizer® 4, manufactured by Beckman Coulter, Inc.), and unless otherwise specified, measured values thereof are rounded to the nearest tenth and indicated to one decimal place.

The toner may further contain a wax, a charge control agent, or de like as needed.

The wax is not particularly limited, and an appropriate wax can be selected from among publicly known waxes. Among such waxes, a low-melting wax having a melting point of 50 to 120° C. is preferred. By dispersing the styrene-acrylic resin, a low-melting wax works effectively as a release agent between a fixing roller and a toner interface, and good hot offset resistance is thereby obtained even in an oil-less configuration (a method in which a release agent such as oil, for example, is not applied to the fixing roller).

Examples of the wax include carnauba wax, cotton wax, Japan wax, rice wax, and other plant-based waxes; beeswax, lanolin, and other animal-based waxes; montan wax, ozokerite, selsyn, and other mineral--based waxes; paraffin, microcrystallin, petrolatum, and other petroleum waxes; and other natural waxes.

Examples also include synthetic waxes such as Fischer-Tropsch wax, polyethylene wax, and other synthetic hydrocarbon waxes; esters, ketones, ethers, and other synthetic waxes.

Furthermore, amides of 12-hydroxystearic acid, amides of stearic acid, imides of anhydrous phthalic acid, and aliphatic amides of chlorinated hydrocarbons and the like; homopolymers or copolymers of poly-n-stearylmethacrylate, poly-n-laurylmethacrylate, and other polyacrylates, which are crystalline polymer resin having low molecular weight, (e.g., n-stearylacryate-ethylmethacrylate copolymer and the like); and crystalline polymers having long alkyl groups in a side chain thereof and the like may be used as the Wax.

Among these, carnauba wax or another natural wax is preferred.

Any of the aforementioned waxes may be used singly, or two or more types thereof may be used in combination.

The melt viscosity of the wax as measured at a temperature 20° C. higher than the melting point of the wax is preferably 5 to 1000 cps, and more preferably 10 to 100 cps.

The content of the wax contained in the toner is not particularly limited, and an appropriate content can be selected according to purpose. As a guideline, the wax content with respect to the total mass of the resin contained in the toner is usually 0.5 to 20%, and preferably 1 to 10%. When the wax is contained in such an amount, “the content of styrene-acrylic resin contained in the toner” may be interpreted as “the total content of styrene-acrylic resin and wax contained in the toner.”

The charge control agent is not particularly limited, and an appropriate charge control agent can be selected from among publicly known charge control agents.

Specific examples thereof include nigrosine-based dyes, triphenyl methane-based dyes, chromium-containing metal complex dyes, molybdenum oxide chelate pigments, rhodamine-based dyes, alkoxy-based amines, quaternary ammonium salts (including fluorine-modified quaternary ammonium salts), alkyl amides, elemental phosphorus or a compound thereof, elemental tungsten or a compound thereof, fluorine-based activators, metal salts of salicylic acid, metal salts of salicylic acid derivatives, and the like.

The aforementioned charge control agents include charge control agents obtainable as commercial products. Examples thereof include the nigrosine-based dye Bontron® 03, the quaternary ammonium salt Bontron® P-51, the metal-containing azo dye Bontron® 34, the oxy-naphthoic acid-based metal complex Bontron® E-82, the salicylic acid-based metal complex Bontron® E-84, and the phenol-based condensation product Bontron® E-89 (each manufactured by Orient Chemical Industries Co., Ltd.); the quaternary ammonium salt molybdenum complexes TP-302 and TP--415 (each manufactured by Hodogaya Chemical Co., Ltd.) ; the quaternary ammonium salt Copy Charge:Pm PSY VP2038, the trphenylmethane derivative Copy Blue PR, the quaternary ammonium salts Copy Charge® NEG VP2036 and Copy Charge® NX VP434 (each manufactured by Hoechst AC); LRA-901 and the boron complex LR-147 (manufactured by Japan Carlit. Co., Ltd.); copper phthalocyanine; perylene; quinacridone; azo-based pigments; or polymer-based compounds having sulfonic acid groups, carboxyl groups, quaternary ammonium salts, and other functional groups; and the like.

The charge control agent may, depending on the type thereof, have low compatibility with the styrene-acrylic resin contained in the toner, and the toner and charge control agent may sometimes be in a dispersed state. Therefore, when the toner and the charge control agent cannot be satisfactorily dispersed, the amount of electric charge on each toner particle becomes non-uniform, and the electric charge distribution of the toner increases in size, which results in staining of the non-image area.

In such situations, a charge control resin is preferably used as the charge control agent. Charge control resins are one type of charge control agent, and charge control resins are known which comprise a styrene-acrylic resin having good compatibility with the toner. Such charge control resins are known to include both resins corresponding to negatively chargeable toners and resins corresponding to positively chargeable toners. Specific examples thereof include the Acrybase FCA series (manufactured by Fujikura Kasei Co., Ltd.). Preferred examples of resins used in negatively chargeable toners include FCA-1001-NS and the like, and preferred examples of resins used in positively chargeable toners include FCA-201-PS, FCA-207P, and the like.

The content of the charge control agent contained in the toner is not particularly limited, and an appropriate content can be selected according to purpose. The content differs according to the type of the resin, the presence or absence of additives, the method of dispersion, and other factors, and is difficult to specify unconditionally. However, as a guideline, the charge control agent content with respect to the total mass of the resin contained in the toner is usually 0.1 to 10%, and preferably 0.2 to 5%.

The abovementioned charge control agents may be used singly or two or more types thereof may be used in combination.

The method for manufacturing the toner will be described.

The method for manufacturing the toner may be a pulverization method for fabricating the toner through processes of kneading, pulverization, and classification; a polymerization method (e.g., emulsion polymerization, solution suspension, emulsion aggregation, polyester extension, and the like) for polymerizing a polymerizable monomer and forming toner particles while simultaneously controlling the shape or size thereof; or another publicly known manufacturing method. Of the methods described above, a method for manufacturing toner by pulverization generally includes the four manufacturing steps 1 through 4 described below.

“Manufacturing Step 1”

A step for mixing a dye, a resin, and, as needed, a charge control agent, a wax, and other components in a Henschel mixer or other mixing machine and obtaining a dye-resin mixture.

“Manufacturing Step 2”

A step for melt-kneading the dye-resin mixture obtained in Manufacturing Step 1 in a sealed kneader, or in a single- or twin-screw extruder or the like, and cooling the mixture to obtain a resin composition.

“Manufacturing Step 3”

A step for coarsely pulverizing the resin composition obtained in Manufacturing Step 2 in a hammer mill or the like, then finely pulverizing the resin composition in a jet mill, classifying the resin composition as needed using a cyclone or various types of classifying machines to obtain the desired particle size distribution, and obtaining toner base particles.

“Manufacturing Step 4”

A step for adding an external additive to the toner base particles obtained in Manufacturing Step 3 and mixing in a Henschel mixer or the like to obtain a toner.

In an electrophotographic process using a toner, an image is generally formed on an intermediate recording medium by the operations (1) through (3) described below.

(1) An electrostatic latent image formed by exposure light on a photosensitive drum or other latent image carrier is developed by a developer using a toner, and a toner image is formed.

(2) The obtained toner image is transferred to paper or another intermediate recording medium by a transfer member, and a toner image is thereby formed on then intermediate recording medium.

(3) The obtained intermediate recording medium is heated and pressed by a fixing device, and the toner image formed on them intermediate recording medium is fixed on the intermediate recording medium. Formation of an image on the intermediate recording medium is thereby completed.

The fixing device is not particularly limited, but is usually one in which a paper sheet is held between a pair of rollers provided with a heater, and heating and pressing are performed while the paper sheet is conveyed by rotation of the rollers. The surface temperature of the rollers is usually raised to about 90 to 190° C. by the heater.

The fixing device may be provided with a cleaning function. The cleaning method may be a method in which silicone oil is supplied to the rollers to clean the rollers; a method in which the rollers are cleaned by a pad, roller, web, or the like impregnated with silicone oil; or another method.

As an example of a sublimation transfer dyeing method, a dyeing method is cited in which a toner is affixed by a publicly known electrophotographic process, for example, to the intermediate recording medium to form a toner image, after which the toner-affixed surface of the intermediate recording medium and an object to be dyed are superposed on each other, and heat treatment is then performed usually at about 190 to 210° C., whereby the sublimable dye in the toner is transfer-dyed from the intermediate recording medium to the object to be dyed, and the toner image on the intermediate recording medium is sublimation-transferred to the object to be dyed.

Examples of the object to be dyed include hydrophobic fibers (or cloth or the like constructed from the same) such as polyester; films, sheets, or the like comprised of a hydrophobic resin, such as PET films or PET sheets; and fabric, glass, metal, ceramic, and the like coated with a hydrophobic resin.

The sublimation transfer dyeing method and toner using the same of the present invention have excellent development characteristics, and make it possible to obtain an intermediate recording medium having an excellent, toner image having almost no fogging even in a contact or non-contact dry development process, particularly in image formation using a full-color large format printer. As a result, staining of the non-image area can be suppressed even while the dye contained in the toner on the intermediate recording medium is sublimation-transferred with high transfer efficiency to the object to be dyed, and it is therefore possible to provide a high-quality dyed product having high dyeing density and no staining of the non-image area

### EXAMPLES

The present invention will be described in further detail below using examples, but these examples do not limit the present invention. Unless otherwise specified, “parts” and “%” are based. on mass in the examples. When the desired amount of a substance is not obtained by a single operation, the same operation is repeated until the desired amount of the substance is obtained.

In the examples, the volume-average particle diameter (D50 Vol.) is measured using a “Multisizer® 4” (manufactured by Beckman Coulter, Inc.) precson particle size distribution measuring device.

### Example 1

(Step I)

ALMATEX CPR-390 (96 parts), C.I. Disperse Blue 359 (14 parts), FCA-1001-MS (2 parts), and Carnauba Wax Cl (3 parts) were premixed for 10 minutes in a Henschel mixer at a rotation speed of 30 m/second, and then melt-kneaded in a twin-screw extruder. The resultant melt-kneaded product was then pulverized/classified using a pulverizing/classifying machine, and a toner base having a volume-average particle diameter of 7.7 μm was thereby obtained.

(Step 2)

The toner base (100 parts) obtained in Example 1 (Step 1), RX50 (1 part), R812 (1 part), and SW-100 (1 part) were then placed in a Henschel mixer and stirred for 10 minutes at a rotation speed of 30 m/second, and a cyan toner of the present invention according to Example 1 was obtained.

### Example 2

(Step 1)

A toner base was obtained by the same procedures as in Example I (Step 1), except that the volume-average particle diameter thereof was 9.7 μm.

(Step 2)

A cyan toner of the present invention according to Example 2 was obtained by the same procedures as in Example 1 (Step 2), except that the toner base (100 parts) obtained in Example 2 (Step 1) was used instead of the toner base (100 parts) obtained in Example 1 (Step 1).

### Example 3

(Step 1)

A toner base was obtained by the same procedures as in Example 1 (Step 1), except that Bontron E-84 (2 parts) was used instead of the FCA-1001-NS (2 parts) used in Example 1 (Step 1) and the volume-average particle diameter thereof was 7.8 μm.

(Step 2)

A cyan toner of the present invention according to Example 3 was obtained by the same procedures as in Example 1 (Step 2), except that the toner base (100 parts) obtained in Example 3 (Step 1) was used instead of the toner base (100 parts) obtained in Example 1 (Step 1).

### Example 4

(Step 1)

A toner base was obtained by the same procedures as in Example 1 (Step 1), except that Bontronm E-84 (2 parts) was used instead of the FCA-1001-NS (2 parts) used in Example 1 (Step 1) and the volume-average particle diameter thereof was 9.8 μm.

(Step 2)

A cyan toner of the present invention according to Example 4 was obtained by the same procedures as in Example 1 (Step 2), except that the toner base (100 parts) obtained in Example 4 (Step 1) was used instead of the toner base (100 parts) obtained in Example 1 (Step 1).

### Comparative Example 1

A toner base (100 parts) obtained by using Bontron® E-84 (2 parts) instead of the FCA-1001-NS (2 parts) used in Example 1 (Step 1) and setting a volume-average particle diameter of 9.7 μm, RX50 (1 part), R812 (0.4 part), and STT-30A (0.3 part) were placed in a Henschel mixer and stirred for 10 minutes at a rotation speed of 30 m/second, and a cyan toner for comparison according to Comparative Example 1 was obtained.

### Comparative Example 2

A toner base (100 parts) obtained by using Bontron® E-84 (2 parts) instead of the FCA-1001-NS (2 parts) used in Example 1. (Step 1) and setting a volume-average particle diameter of 9.7 μm, RX50 (0.5 part), R812 (1 part), and EC-300 (0.5 part) were placed in a Henschel mixer and stirred for 10 minutes at a rotation speed of 30 m/second, and a cyan toner for comparison according to Comparative Example 2 was obtained.

### Comparative Example 3

A toner base (100 parts) obtained by using Bontron® E-84 (2 parts) instead of the FCA-1001-1\1S (2 parts) used in Example 1 (Step 1) and setting a volume-average particle diameter of 7.9 μm, RX50 (0.5 part), R812 (1 part), and STT-30A (0.3 part) were placed in a Henschel mixer and stirred for 10 minutes at a rotation speed of 30 m/second, and a cyan toner for comparison according to Comparative Example 3 was obtained.

### Comparative Example 4

A toner base (100 parts) obtained by the same procedures as in Example 1 (Step 1) except that the volume-average particle diameter was set to 7.9 μm, RX50 (0.5 part), R812 (1 part), and STT-30A (0.3 part) were placed in a Henschel mixer and stirred for 10 minutes at a rotation speed of 30 m/second, and a cyan toner for comparison according to Comparative Example 4 was obtained.

### Comparative Example 5

A toner base (100 parts) obtained by the same procedures as in Example 1 (Step 1) except, that the volume-average particle diameter was set to 9.8 μm, RX50 (0.5 part), R812 (1 part), and STT-30A (0.3 part) were placed in a Henschel mixer and stirred for 10 minutes at a rotation speed of 30 m/second, and a cyan toner for comparison according to Comparative Example 5 was obtained.

The components of the toners in the examples and comparative examples described above are listed in Table 1 below.

[Evaluation of Non-image Area Staining in the Dyed Product]

Non-image area staining in the dyed product was evaluated by the two methods described in [A. Evaluation by Colorimetry] and [B. Visual Evaluation] described below. The evaluation results are indicated in Table 2 below.

[A. Evaluation by Colorimetry]

Each cyan toner obtained in the examples and comparative examples was charged into a printer operating according to a dry nonmagnetic one-component development process (KIPc7800, manufactured by Kansuragawa Electric Co, Ltd.). Using A0-size bond paper as the intermediate recording medium, printing was performed under condons of a resolution of 600 pixel/inch, a fixing temperature of 135° C., and a developing bias of 200 V, and four types of intermediate recording media (bond paper) to which the cyan toners were affixed were obtained.

The toner -affixed surface of each resultant intermed date recording medium and a double pique (weight: 90 g/m²) configured from 100% polyester fibers as the object to be dyed were superposed on each other, then heat--treated at 195° C. for 60 seconds using a heating press machine (transfer press machine TP-600A2, manufactured by Horizon International Inc.), whereby double pique dyed products dyed by a sublimation transfer dyeing method were obtained.

The non-image portions of the resultant dyed products were subjected to colorimetry using a “SpectroEye (manufactured by Gretaghacbeth GmbH)” spectrophotometer, and the degree of staining of the non--image area was measured. When a double pique was subjected to colorimetry in the same manner prior to dyeing, the measured value was 0.06. This numerical value therefore indicates a complete absence of staining of the non-image area.

[B. Visual Evaluation]

The degree of staining of the non-image portion subjected to colorimetry was visually observed in the dyed products used in [A. Evaluation by Colorimetry], and evaluated according to the four levels of standards described below. Severe staining of the non-image area is apparent when the colorimetry value exceeds 0.10, and is not practically acceptable.

A: Staining of the non-image area is not observed.

B: Extremely slight staining of the non-image area is observed.

C: The presence of staining of the non-image area is clearly observed.

D: Severe staining of the non-image area is observed.

The meanings of the codes in Table 1 are illustrated below.

CPR-390: ALMATEX CPR--390 manufactured by Mitsui. Chemicals, Inc.

DB359: C.I. Disperse Blue 359

Ti-Sr: strontium titanate

SW-100: SW-100 manufactured by Titan Kogyo, Ltd Si: silica

RX50: ARROSIL RX50 manufactured by Nippon Aerosil Co., Ltd.

R812: AEROSIL® P812 manufactured by Nippon Aerosil Co., Ltd.

H2000/4: H2000/4 manufactured by Clariant (Japan) K.K. TiO₂: titanium dioxide STT-30A: STT-30A manufactured by Titan Kogyo, Ltd. EC-300: EC-300 manufactured by Titan Kogyo, Ltd.

Cl: Carnauba Wax Cl manufactured by S. Kato & Co.

FCA: FC-A-1001-NS manufactured by Fujikura Kasei Co., Ltd.

E-84: Bontron® E-84 manufactured by Orient Chemical Industries Co., Ltd.

The “-” symbol means that the component is not contained.

TABLE 1

| Component composition | | Examples | | | | Comparative Examples | | | | |
|---|---|---|---|---|---|---|---|---|---|---|
| and D50 Vol | | 1 | 2 | 3 | 4 | 1 | 2 | 3 | 4 | 5 |
| Resin | | CPR-390 | CPR-390 | CPR-390 | CPR-390 | CPR-390 | CPR-390 | CPR-390 | CPR-390 | CPR-390 |
| Dye | | DB359 | DB359 | DB359 | DB359 | DB359 | DB359 | DB359 | DB359 | DB359 |
| External additive | Ti—Sr | SW-100 | SW-100 | SW-100 | SW-100 | — | — | — | — | — |
| | SiO₂ | RX-50 | RX-50 | RX-50 | RX-50 | RX-50 | RX-50 | RX-50 | RX-50 | RX-50 |
| | | R-812 | R-812 | R-812 | R-812 | R-812 | R-812 | R-812 | R-812 | R-812 |
| | TiO₂ | — | — | — | — | STT-30A | EC-300 | STT-30A | STT-30A | STT-30A |

| | | | | | | | | | |
|---|---|---|---|---|---|---|---|---|---|
| Wax | C1 | C1 | C1 | C1 | C1 | C1 | C1 | C1 | C1 |
| CCA | FCA | FCA | E-84 | E-84 | E-84 | E-84 | E-84 | FCA | FCA |
| D50 | 7.7 | 9.7 | 7.8 | 9.8 | 9.7 | 9.7 | 7.9 | 7.9 | 9.8 |

TABLE 2

Staining of non-image area

| | | |
|---|---|---|
| Evaluation results | Colorimetry value | Visual |

| | | | |
|---|---|---|---|
| Example | 1 | 0.07 | A |
| | 2 | 0.09 | B |
| | 3 | 0.07 | A |
| | 4 | 0.09 | B |
| Comparative Example | 1 | 0.13 | D |
| | 2 | 0.11 | D |
| | 3 | 0.11 | D |
| | 4 | 0.11 | D |
| | 5 | 0.14 | D |

As is clear from Table 2, it was confirmed that in the dyed products obtained in the examples, the colorimetry values of the non-image area portions were markedly lower than in the comparative examples. By visual observation as well, there was almost no staining of the non-image area, or staining was observed only to a slight degree, and it is apparent that staining of the non-image area of the dyed products was suppressed.

The dyeing density in portions of the dyed products in which the printing output was 100% was also measured using the aforementioned spectrophotometer. It was confirmed from the results thereof that the dyed products of the examples had an extremely high dyeing density of 1.52, the same as in the comparative examples, and practically adequate performance was obtained with respect to dyeing density as well.

In Example 1 and Comparative Example 4, Example 2 and Comparative Example 5, Example 3 and Comparative Example 3, and Example 4 and Comparative Examples 1 and 2 in particular, strontium titanate being contained in each example and titanium oxide being contained in each comparative example having the same blend, comparison between the examples and comparative examples indicates that the addition of strontium titanate makes it possible to suppress staining of the non-image area of the dyed products.

### INDUSTRIAL APPLICABILITY

The sublimation transfer dyeing method of the present invention is capable of providing a high-Quality dyed product having high dyeing density and no staining of the non-image area, and has performance sufficient for practical use, and is therefore extremely useful as a sublimation transfer dyeing method using an electrophotographic process.

1. A sublimation transfer dyeing method, comprising:
attaching a toner to an intermediate recording medium by an electrophotographic process, and
sublimation-transferring a dye contained in the toner attached to the intermediate recording medium to an object to be dyed, wherein the toner contains at least a styrene-acrylic resin, a sublimable dye, and an external additive, and
wherein the external additive contains at least strontium titanate.

2. The sublimation transfer dyeing method according to claim 1, wherein the electrophotographic process is a dry development process.

3. The sublimation transfer dyeing method according to claim 1, wherein the object to be dyed is selected from the group consisting of a hydrophobic fiber or a structure thereof, a film or sheet comprised of a hydrophobic resin, and a fabric, glass, metal, and ceramics coated with a hydrophobic resin.

4. A dyed product dyed by the sublimation transfer dyeing method according to claim 1.

5. A toner used in the sublimation transfer dyeing method according to claim 1, wherein the toner contains at least a styrene-acrylic resin, a sublimable dye, and an external additive, and
wherein the external additive contains at least strontium titanate.

6. An intermediate recording medium used in the sublimation transfer dyeing method according to claim 1,
wherein a toner is attached to the intermediate recording medium, wherein the toner contains at least a styrene-acrylic resin, a sublimable dye, and an external additive, and
wherein the external additive contains at least strontium titanate.

7. A method for suppressing staining of a non-image area, using the sublimation transfer dyeing method according to claim 1.

8. A dyed product dyed by the sublimation transfer dyeing method according to claim 1, in which staining of a non-image area is suppressed.

9. A method for suppressing staining of a non-image area, using the toner according to claim 5.

10. A method for suppressing staining of a non-image area, using the intermediate recording medium according to claim 6.

11. An intermediate recording medium to which the toner according to claim 5 is attached.

12. The sublimation transfer dyeing method according to claim 2, wherein the object to be dyed is selected from the group consisting of a hydrophobic fiber or a structure thereof, a film or sheet comprised of a hydrophobic resin, and a fabric, glass, metal, and ceramics coated with a hydrophobic resin.

13. A dyed product dyed by the sublimation transfer dyeing method according to claim 2.

14. A toner used in the sublimation transfer dyeing method according to claim 2, wherein the toner contains at least a styrene-acrylic resin, a sublimable dye, and an external additive, and
wherein the external additive contains at least strontium titanate.

15. An intermediate recording medium used in the sublimation transfer dyeing method according to claim 2,
wherein a toner is attached to the intermediate recording medium,
wherein the toner contains at least a styrene-acrylic resin, a sublimable dye, and an external additive, and
wherein the external additive contains at least strontium titanate.

16. A method for suppressing staining of a non-image area, using the sublimation transfer dyeing method according to claim 2.

17. A dyed product dyed by the sublimation transfer dyeing method according to claim 2, in which staining of a non-image area is suppressed.

18. A method for suppressing staining of a non-image area, using the toner according to claim 14.

19. A method for suppressing staining of a non-image area, using the intermediate recording medium according to claim 15.

20. An intermediate recording medium to which the toner according to claim 14 is attached.
